(19) United States
(12) Patent Application Publication
(10) Pub. No.: US 2003/0054124 A1
(43) Pub. Date: Mar. 20, 2003

(54) Easy opening packaging for food products

(75) Inventor: Alexandre Paviot, Lyon (FR)

Correspondence Address: Ira J. Schultz, DENNISON, SCHULTZ & DOUGHERTY, Suite 612, 1745 Jefferson Davis Highway, Arlington, VA, 22202, US

(73) Assignee: Papiers a Paviot

(21) Appl. No.: 10/235,723

(22) Filed: Sep. 6, 2002

(30) Foreign Application Priority Data
Sep. 14, 2001 (FR) 01 11 900

(51) Int. Cl. B32B 1/02

(52) U.S. Cl. 428/35.2; 428/141

(57) ABSTRACT

The packaging for food products of the invention is intended to comprise two superimposed composite sheets (4, 5), each composite sheet comprising at least one layer made of a heat-sealable plastic material (14) forming the inner surface of the packaging.

According to the invention, each heat-sealable plastic layer (14) exhibits a BENDTSEN DIN 53108 surface roughness less than or equal to 1200 ml/min and in that the heat-sealable plastic layers (14) collectively have a coefficient of friction of less than or equal to 0.5 so as to ensure easy opening of the casing.

The present invention concerns the technical field relating to the packaging of products on their sale and/or packaging outlet and in particular food products sold retail, wholesale in small quantities.

Preferably but not exclusively, the present invention concerns a packing appearing in the form of a casing intended to be cut as required and be seal-closed.

In the field for the packing of food products, the patent F R 2 775 252 concerned using a casing composed, at least in part, of a heat-sealable material. This casing is made up from two superimposed sheets and assembled (by glueing or welding for example) at the level of their longitudinal edges. Each composite sheet comprises an external layer of aluminium, an internal layer of low density polyethylene and a layer of paper covered with a low density layer of polyethylene. This casing packed into a roll is intended to be cut on the site of use into a length slightly larger than that of the product to be packed. Preferably, one extremity of the casing is cut and closed simultaneously by heat-sealing so as to produce a bag. Then, after the product to be packed has been inserted in the bag, the other extremity of the casing is heat-sealed so as to obtain a sealed packaging.

The use of this packaging casing is particularly useful for the packaging of fresh or frozen food products, such as fish and meat, during the retail, wholesale or wholesale in small quantities of said products.

However, so as to introduce the product to be packed in the bag, the user needs to open it by pulling apart the composite sheets. Now in certain use conditions, it is sometimes difficult to open the bag, especially when the user has wet hands or wears gloves.

The present invention seeks to resolve the drawbacks mentioned above and concerns providing a new packing for food products to be closed by heat-sealing and designed in such a way as to permit easy opening of the package so as to introduce into it the product to be packed, even for a user having wet hands or wearing gloves.

So as to reach this objective, the present invention concerns a packing for food products and intended to comprise two superimposed composite sheets, each composite sheet comprising at least one layer of a heat-sealable plastic layer forming the internal surface of the packing. According to the invention, each layer of heat sealable plastic possesses a BENDTSEN DIN 53108 surface roughness of less than or equal to 1200 ml/min and in that the heat-sealable plastic layers collectively have a coefficient of friction less than or equal to 0.5 so as to ensure easy opening of the casing.

Various other characteristics appear from the description detailed below with reference to the accompanying drawings which show by way of non-restrictive examples embodiments of the invention.

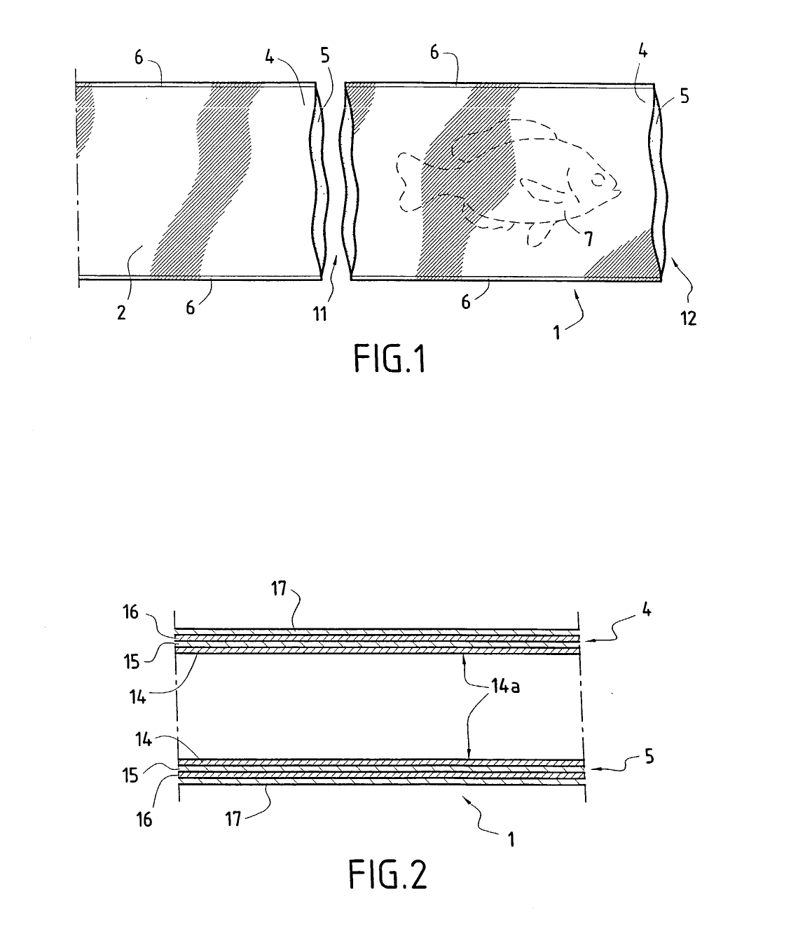

FIG. 1 is a top view showing an embodiment example of a packing conforming to the invention.

FIG. 2 is large scale sectional view showing the structure of a packing according to the invention.

FIG. 1 represents an embodiment of a packing 1 appearing in the form of a casing cut from a casing 2 generally packed into a roll. In the example shown, the casing 2 comprises two superimposed composite sheets 4, 5 which, in the example shown, are assembled together at the level of their longitudinal edges 6 by welding, glueing or mechanical assembling for example. This casing 2 is cut to the desired length so as to contain a food product 7, such as fish. Preferably, during cutting of the casing 2 to constitute the packing 1, a transversal weld connecting the two longitudinal edges 6 is carried out on one extremity 11 of the packing 12 which thus appears in the form of a bag able to be opened by the other transversal extremity 12 having an opening giving access to the internal volume of the bag.

According to one characteristic of the invention, each composite sheet 4, 5 comprises at least one layer 14 of a heat-sealable or heat-weldable plastic material having an external surface 14a forming the entire internal surface of the casing, as clearly shown on FIG. 2. Thus, each composite sheet 4, 5 has a layer of a heat-sealable material 14 opposite each other via their external surface 14a so as to ensure the heat-welding of the two sheets 14. Thus, as the layers of the heat-sealable plastic material are placed against each other, the application of pressure localised between the sheets 4, 5, for example at the level of the transversal edges of the casing, completed by a localised heating makes it possible to weld the sheets.

It is essential that each composite sheet 4, 5 comprises at least one layer of a heat-sealable plastic material.

According to a preferred embodiment characteristic to be described in the continuation of the description, the material making up the heat-sealable plastic material 14 is a low density polyethylene. Of course, the heat-sealable plastic layer can be embodied with a different material, such as propylene, glue or heat-sealable wax or a layer of a heat-sealable layer deposited by dispersion.

In accordance with the invention, each heat-sealable plastic layer 14 exhibits a surface roughness according to the BENDTSEN DIN 53 108 technique less than or equal to 1200 millilitres per minute and, according to one advantageous characteristic, is between 800 and 1200 ml/min and preferably about 910 ml/min.

Surface roughness can be obtained on each heat-sealable plastic layer 14 by means for example of a heavy rough cylinder coming into contact with the external surface 14 of the heat-sealable plastic layer 14. For example, the heat-sealable plastic layer is embodied via the extrusion of EAA (ethylene-acrylic-acid) copolymers, additives for low density polyethylene and from all low density polyethylenes. All the types of extrusion or coextrusion via coating are included in the invention.

According to another characteristic of the invention, the heat-sealable plastic layers 14 possess a coefficient of friction less than or equal to 0.5 and preferably between 0.25 and 0.35 and even better about 0.3 as per the standard DIN 53 375.

This coefficient of friction can be obtained via the extrusion or coextrusion of specific polymers (certain types of modified low density polyethylenes) and/or by the addition of at least one sliding agent, such as the product with the reference 252 CII commercialised under the sales name EXXON.

The combined implementation of heat-sealable plastic layers 14 having a specific surface roughness associated with a specific coefficient of friction make it possible to ensure easy opening of the casing. In fact, this packing 1 can be easily opened, even with wet hands or those wearing gloves from its free edges via a simple rubbing movement between the two sheets 4, 5. This easy opening is possible by virtue of the present invention and its “easy casing opening” and by a determination of the friction, surface roughness and slidings of the heat-sealable plastic layers 14 against each other.

According to a preferred embodiment characteristic, each composite sheet 4, 5 comprises the heat-sealable plastic layer 14 placed on a paper layer 15 preferably with a high mechanical resistance. Each composite sheet 4, 5 preferably also comprises one internal heat-sealable plastic layer 16 inserted between the paper layer 15 and the external aluminium layer 17 preferably covered with a varnish for printing.

In the example described above, the casing forming the packing 1 is constituted from two composite sheets 4, 5 placed in a superimposed position with one against the other and assembled along their two longitudinal edges 6. Of course, it is possible to embody the packing 1 in the form of a casing without using a weld or even a casing with a single weld obtained by folding back a sheet onto itself and by welding the free edges opposite the fold. Similarly, the packing 1 can be embodied from a folding of a sheet onto itself so as to obtain the two superimposed sheets 4, 5 which are assembled at the level of their edges so as to constitute a bag comprising an opening with access to its internal volume which is closed by heat weld after introducing the product to be packed inside the packing. Generally speaking, the packing of the invention is intended to comprise at least two superimposed composite sheets 4, 5 as described above and which, when assembled at the level of their edges by glueing, welding or mechanical assembling, make it possible to constitute a bag with an opening for introduction of the product to be packed. The opening of the bag is then closed by heat weld, as explained above.

Moreover, it is possible for each composite sheet 4, 5 to comprise a structure differing from the one described. For example, the internal heat-sealable plastic layer 16 can be replaced by a layer of glue. It is possible to use a material not comprising aluminium. However, each composite sheet 4, 5 should have at least one heat-sealable plastic layer so as to allow the two sheets to be heat-welded.

1. Packing for food products and intended to comprise two superimposed sheets (4, 5), each composite sheet comprising at least one layer of a heat-sealable plastic material (14) forming the internal surface of the packing, characterised in that each heat-sealable plastic layer (14) exhibits a BENDTSEN DIN 53108 surface roughness less than or equal to 1200 ml/min and in that the heat-sealable plastic layers (14) collectively have a coefficient of friction less than or equal to 0.5 so as to ensure easier opening of the casing.

2. Packing according to claim 1, characterised in that each heat-sealable plastic layer (14) exhibits a BENDTSERN DIN 53108 surface roughness of between 800 and 1200 ml/min and preferably about 910 ml/min.

3. Packing according to claim 1 or 2, characterised in that the heat-sealable plastic layers (14) collectively have a coefficient of friction of between 0.25 and 0.35 and preferably about 0.3.

4. Packing according to one of claims 1 to 3, characterised in that each heat-sealable plastic layer (14) is embodied by an extrusion and/or coextrusion of polymers.

5. Packing according to one of claims 1 to 4, characterised in that each heat-sealable plastic layer (14) comprises at least one sliding agent.

6. Packing according to claim 1, characterised in that each composite sheet (4, 5) comprises one external aluminium layer (17), one internal layer of a heat-sealable plastic material (16) and a paper layer (15) covered by the heat-sealable plastic layer (14).

7. Packing according to claim 1, characterised in that each composite sheet (4, 5) comprises an external layer of aluminium (17), a layer of glue and a paper layer (15) covered by the heat-sealable plastic layer (14).

8. Packing according to one of claims 1 to 7, characterised in that the material constituting the heat-sealable plastic layer (14) is a low density polyethylene.

9. Packing according to one of claims 1 to 8, characterised in that the two superimposed composite sheets (4, 5) form a casing.

10. Packing according to one of claims 1 to 8, characterised in that the two superimposed composite sheets (4, 5) are obtained by the folding of a sheet onto itself.

11. Packing according to claim 9 or 10, characterised in that the two superimposed composite sheets (4, 5) are assembled at the level of their edges so as to constitute a bag comprising an opening for access to its internal volume.
